(19) United States
(12) Patent Application Publication
(10) Pub. No.: US 2023/0367849 A1
(43) Pub. Date: Nov. 16, 2023

(54) ENTROPY EXCLUSION OF TRAINING DATA FOR AN EMBEDDING NETWORK

(71) Applicant: CrowdStrike, Inc., Irvine, CA (US)

(72) Inventors: Marian Radu, Jyvaskyla (FI); Daniel Radu, Bucharest (RO)

(21) Appl. No.: 17/745,762

(22) Filed: May 16, 2022

(51) Int. Cl. G06K 9/62; G06N 20/00

(52) U.S. Cl. CPC G06K 9/6232; G06K 9/6256; G06N 20/00

(57) ABSTRACT

Methods and systems are provided for entropy exclusion of labeled training data by extracting windows therefrom, for training an embedding learning model to output a feature space for a feature space based learning model. Based on feature embedding by machine learning, a machine learning model is trained to embed feature vectors in a feature space which magnifies distances between features of a labeled dataset. Before training, however, sub-sequences of bytes are extracted from each sample of the labeled subset, based on a window size hyperparameter and a window distance hyperparameter. Information entropy is computed for each among a set of extracted windows, and extracted windows having highest information entropy, as well as extracted windows having lowest information entropy, are excluded therefrom. Extracted windows of the subset are stored in a data stream and accessed sequentially to derive feature vectors.

### BACKGROUND

In computer security, the detection of malware is perennially a challenging problem, as malware is designed to evade known detection methods by eliminating, obfuscating, or concealing known discriminating features by which malware may be distinguished from benign software. With every such evasive change in malware design, security experts must identify new discriminating features which are common to at least some families of malware, while being absent from benign software. Antivirus software and other such computer-executable applications may be installed on computing systems and programmed with computer-executable instructions to recognize these discriminating features, so as to halt the execution of malware to prevent compromising of computing system functionality.

Security experts may be able to successfully identify discriminating features of malware through manual inspection of malware samples to conduct feature engineering, though such feature engineering is a high-cost endeavor due to levels of expertise required. Security services which provide rapid and adaptive recognition of malware are increasingly important, with the growth of malware which renders recovery of system functionality after infection greatly onerous or impossible. Thus, it is desirable to enable computing systems to recognize discriminating features of malware without human intervention.

Machine learning technologies may be deployed to enable computing systems to be trained to recognize discriminating features of malware from samples of known malware and known benign software, and thereby classify previously unseen computer-executable applications as either malware or benign. Such machine learning technologies are still at a nascent stage, and it is desirable to improve the robustness of such machine learning as applied to a variety of emergent malware, not all of which may include the same discriminating features, thus rendering no single method of recognition as universally effective.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an architectural diagram of a cloud computing system according to examples of the present disclosure.

FIG. 2 illustrates a diagram of a feature space based learning model according to examples of the present disclosure.

FIG. 3 illustrates a diagram of an embedding learning model according to examples of the present disclosure.

FIG. 4A illustrates a flowchart of an embedding training method according to examples of the present disclosure.

FIG. 4B illustrates a layout of an executable file according to examples of the present disclosure.

FIG. 5 illustrates an architectural diagram of an embedding learning model according to examples of the present disclosure.

FIG. 6 illustrates an example system for implementing the processes and methods described herein for implementing embedding learning models and entropy exclusion of labeled training data.

### DETAILED DESCRIPTION

Systems and methods discussed herein are directed to implementing data preprocessing for learning models, and more specifically performing entropy exclusion of labeled training data by extracting windows therefrom, for training an embedding learning model to output a feature space for a feature space based learning model.

In the routine course of business operations and day-to-day transactions, organizations and enterprises host various computing services for end users, organizational personnel, and other internal and external users on one or more networks. A network can be configured to host various computing infrastructures; computing resources; computer-executable applications; databases; computing platforms for deploying computer-executable applications, databases, and the like; application programming interface (“API”) backends; virtual machines; and any other such computing service accessible by internal and external accessing the network from one or more client computing devices, external devices, and the like. Networks configured to host one or more of the above computing services may be characterized as private cloud services, such as data centers; public cloud services; and the like. Such networks may include physical hosts and/or virtual hosts, and such hosts may be located in a fashion collocated at premises of one or multiple organizations, distributed over disparate geographical locations, or a combination thereof.

A network can be configured by a network administrator over an infrastructure including network hosts and network devices in communication according to one or more network protocols. Outside the network, any number of client computing devices, external devices, and the like may connect to any host of the network in accordance with a network protocol. One or more networks according to examples of the present disclosure may include wired and wireless local area networks (“LANs”) and such networks supported by IEEE 802 LAN standards. Network protocols according to examples of the present disclosure may include any protocol suitable for delivering data packets through one or more networks, such as, for example, packet-based and/or datagram-based protocols such as Internet Protocol (“IP”), Transmission Control Protocol (“TCP”), User Datagram Protocol (“UDP”), other types of protocols, and/or combinations thereof.

A network administrator can control access to the network by configuring a network domain encompassing computing hosts of the network and network devices of the network. For example, one or more private networks, such as an organizational intranet, can restrict access to client computing devices authenticated by security credentials of an organization, compared to one or more public networks such as the Internet.

Computing hosts of the network may be servers which provide computing resources for hosted frontends, backends, middleware, databases, applications, interfaces, web services, and the like. These computing resources may include, for example, computer-executable applications, databases, platforms, services, virtual machines, and the like. While any of these hosted elements are deployed and running over the network, one or more respective computing host(s) where the element is hosted may be described as undergoing uptime. While these hosted elements are not running and/or not available, the network and one or more respective computing host(s) where the element is hosted may be described as undergoing downtime.

Routine business operations and transactions of organizations and enterprises increasingly rely upon networks, computing hosts, and hosted services remaining free from disruptions in security and disruptions in uptime. Security and uptime can be compromised by one or more computing hosts of the network being configured by malware to execute malicious instructions, which can disrupt or damage computing resources or hosted services; induce downtime in computing resources or hosted services; breach security and/or access controls of one or more networks; allow arbitrary computer-executable instructions to run on one or more computing hosts; and so on.

Network administrators, cybersecurity researchers, and such personnel of an organization will routinely encounter unidentified files introduced to one or more networks of an organization or enterprise, and such unidentified files may be computer-executable files which cause processors of computing hosts of the network to run one or more potentially malicious processes. Any such unidentified file and potentially malicious processes induced by unidentified files could potentially give rise to malware infection.

Security tools can run on computing hosts to configure computing hosts to perform various measures to prevent malware infections in real time. However, networks include many computing hosts, each of which can run dozens or hundreds of processes concurrently and store thousands or millions of unidentified files. As such, the number of potential threats represented by unidentified files across a network vastly outstrips the computational resources available to scan and identify such unidentified files. Security tools therefore configure computing hosts to scan unidentified files in real time as they arrive at a network, by download, transfer from external computer-readable media, or otherwise. Since some malware can configure a computing host to immediately start running malicious processes upon being downloaded or transferred, a real-time scan may fail to prevent a malicious process from running after a file is fully downloaded or transferred.

Post hoc, after potentially malicious processes have run and unidentified files have been collected as samples, network administrators, cybersecurity researchers, and such personnel may store samples of unidentified files in records of databases, and may identify contextual information, such as filenames, file formats, dates and times when files arrived at a network, pathways by which the files run processes on a computing host, and the like. Using such information, unidentified files can be matched against identified malware samples. However, during real-time scanning, computing hosts may not have the luxury of time to perform such detailed analysis.

Due to the unpredictable, ad-hoc, and idiosyncratic natures of malware infections, there is often insufficient time for a computing host scanning unidentified file in real time to conclusively identify the file by comparison to known file samples. Given that files are scanned in real time, computing hosts are configured to scan incomplete object code, and therefore cannot necessarily identify filenames, file formats, nature of the computer-executable instructions encoded in the object code, and the like.

Consequently, security tools can configure computing systems to, based on features of at least partial object code of an unidentified file, classify the unidentified file as a malware file or as a benign file concealing malware; as a benign file; as a potentially malicious file requiring quarantine for further analysis; and the like. Alternatively, security tools can configure computing systems to, based on features of at least partial object code of an unidentified file, place the unidentified file in a feature space and assigning it to one or more clusters of data points representing other identified files, so as to characterize the unidentified file by labels of one or more of these clusters. Alternatively, security tools can configure computing systems to, based on features of at least partial object code of an unidentified file, determine whether the unidentified file is a statistical outlier, a statistical anomaly, and the like among a dataset including statistically normal data points and statistical outlier or statistically anomalous data points.

Consequently, organizations and enterprises can, by extracting features from one or more sample datasets (which can include data points labeled as malware, as a benign file, and the like), configure a computing host to train a learning model (which can be a classification learning model, a clustering learning model, an anomaly detection learning model, and the like) to embed feature vectors in a feature space. Regardless of the nature of a learning model, the computing host should be configured to embed feature vectors in a feature space so as to magnify distances between at least some data points labeled as malware and at least some data points labeled as benign files.

A learning model, according to examples of the present disclosure, may be a defined computation algorithm executable by one or more processors of a computing system to perform tasks that include processing input having various parameters and outputting results. A learning model may be, for example, a layered model such as a deep neural network, which may have a fully-connected structure, may have a feedforward structure such as a convolutional neural network (“CNN”), may have a backpropagation structure such as a recurrent neural network (“RNN”), or may have other architectures suited to the computation of particular tasks. Tasks may include, for example, classification, clustering, anomaly detection, matching, regression, and the like.

According to examples of the present disclosure, another learning model may be an embedding learning model. Whereas other learning models may be trained using labeled data to perform tasks as classification, clustering, anomaly detection, and the like as described above, an embedding learning model may be trained using labeled data to embed features of the labeled data in a feature space, and then output the feature space so that other learning models, such as a classification learning model, a clustering learning model, an anomaly detection learning model, and the like, may place data points into this feature space in performing their respective tasks.

A computing host performing tasks such as classification, clustering, anomaly detection, and the like, with regard to examples of the present disclosure, may ultimately determine whether an unidentified file, represented as a data point in a feature space, is closer to data points labeled as malware, data points labeled as benign files, or data points otherwise labeled. Thereby, a computing host can be configured to classify the unidentified file according to one of several labels; characterize the unidentified file by labels of one or more clusters; characterize the unidentified file as statistically normal or a statistical outlier or statistically anomalous; and the like. However, methods and systems according to examples of the present disclosure need not reach these outcomes.

For the purpose of examples of the present disclosure, one or more methods and/or systems can cause a computing host to output at least a feature space. A feature space may include a description of an n-dimensional vector space, and include one or more mappings by which vectors in real vector space IR may be mapped to the n-dimensional vector space. By methods and systems according to examples of the present disclosure, a computing host can further output classifications of unlabeled executable files, clusterings of unlabeled executable files, determinations of unlabeled executable files as outliers or anomalous, and the like, to distinguish malware from benign software; however, such further outputs are not necessary to perform the objectives of the present disclosure.

Cloud computing systems can be configured to provide collections of servers hosting computing resources to provide distributed computing, parallel computing, improved availability of physical or virtual computing resources, and such benefits. Cloud computing systems can be configured to host learning models to provide these benefits for the application of computing using learning models. Learning models may be trained to derive parameters and weights which may be stored on storage of the cloud computing system and, upon execution, loaded into memory of the cloud computing system.

A cloud computing system may connect, over one or more networks, to various client computing devices which forward data in association with various tasks for the computation and output of results required for the performance of those tasks. Client computing devices may connect to the cloud computing system through edge nodes of the cloud computing system. An edge node may be any server providing an outbound connection from connections to other nodes of the cloud computing system, and thus may demarcate a logical edge, and not necessarily a physical edge, of a network of the cloud computing system. Moreover, edge nodes may include edge-based logical nodes that deploy non-centralized computing resources the cloud computing system, such as cloudlets, fog nodes, and the like.

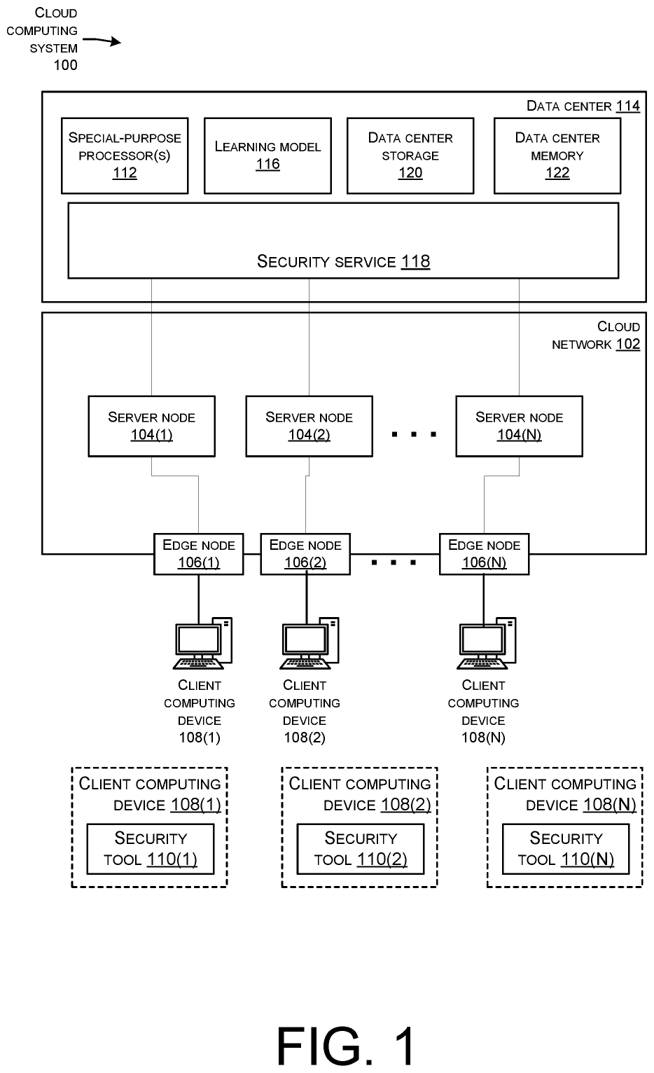

FIG. 1 illustrates an architectural diagram of a cloud computing system 100 according to examples of the present disclosure. The cloud computing system 100 may be implemented over a cloud network 102 of physical or virtual server nodes 104(1), 104(2), . . . , 104(N) (where any unspecified server node may be referred to as a server node 104) connected by physical or virtual network connections. Furthermore, the cloud network 102 terminates at physical or virtual edge nodes 106(1), 106(2), . . . , 106(N) (where any unspecified edge node may be referred to as an edge node 106) located at physical and/or logical edges of the cloud network 102. The edge nodes 106(1) to 106(N) may connect to any number of client computing devices 108(1), 108(2), . . . , 108(N) (where any unspecified client computing device may be referred to as a client computing device 108). A client computing device 108, such as, by way of example, client computing device 108(1), may run a respective instance of a security tool 110(1), 110(2), . . . , 110(N) (where any unspecified security tool instance may be referred to as a security tool 110).

Security tools 110 may be, generally, computer-executable applications which enable, when executed by a client computing device 108, the client computing device 108 to communicate with a security service 118 over the cloud network 102 to access a variety of hosted services provided by the security service 118 to users of a client computing device 108. Users of a client computing device 108 may operate a frontend provided by the respective security tool 110 running on the client computing device 108 so as to access the hosted services of the security service 118 over one or more network connections.

For example, security tools 110 can include various analytics tools for investigating unidentified files of any arbitrary file format arriving at any computing systems and/or networks, system and/or network monitoring tools that monitor computing systems and/or networks for arrivals of unidentified files in real time, incident reporting tools that receive reports of potential intrusions or infection from unidentified files from organizational personnel, and the like, without limitation; different client computing devices 108 can run different such security tools 110 or multiple such security tools. Functions of security tools 110 can include, for example, blocking security holes and security exploits; filtering inbound and outbound connections; policy enforcement; scanning and analysis of data and computer-executable files; and the like. Such functions can be performed at least in part by hosted services providing backend functionality.

Hosted services of a security service 118 may be executed by one or more physical or virtual processor(s) of the cloud computing system 100 in response to operations performed by, or operations performed by an end user through, a security tool 110 running on any of the client computing devices 108 by the exchange of data and communication between the client computing devices 108 and the security service 112 over the cloud network 102.

Hosted services of a security service 118 can include one or more learning models. A learning model can be implemented on special-purpose processor(s) 112, which may be hosted at a data center 114. The data center 114 may be part of the cloud network 102 or in communication with the cloud network 102 by network connections. Special-purpose processor(s) 112 may be computing devices having hardware or software elements facilitating computation of neural network computing tasks such as training and inference computations. For example, special-purpose processor(s) 112 may be accelerator(s), such as Neural Network Processing Units (“NPUs”), Graphics Processing Units (“GPUs”), Tensor Processing Units (“TPU”), implementations using field programmable gate arrays (“FPGAs”) and application specific integrated circuits (“ASICs”), and/or the like. To facilitate computation of tasks such as training and inference, special-purpose processor(s) 112 may, for example, implement engines operative to compute mathematical operations such as matrix operations and vector operations.

A learning model 116 may be stored on physical or virtual storage of the data center 114 (“data center storage 120”), and may be loaded into physical or virtual memory of the data center 114 (“data center memory 122”) (which may be dedicated memory of the special-purpose processor(s) 112) alongside trained weight sets, configuring the special-purpose processor(s) 112 to execute the learning model 116 to compute input related to one or more tasks. The input may be obtained from one or more client computing devices 108 over a network connection from a client computing device 108.

Execution of the learning model 116 may then cause the data center 114 to load the learning model 116 into data center memory 122 and compute results. The learning model 116 may output results required for the performance of heterogeneous functions of the security service 118. The security service 118 hosted on the cloud computing system 100 may provide centralized computing for any number of security tools 110 by acting upon results output by the learning model 116 and communicate over the cloud network 102 to cause the security tools 110 running on the client computing devices 108 to act upon instructions derived from the results output by the learning model 116.

According to examples of the present disclosure, the data center 114 may be substantially high in computing power compared to client computing devices 108. The data center 114 may aggregate computing resources from a variety of networked and/or distributed physical and/or virtual computing nodes, whereas client computing devices 108 may be individual computing systems. Thus, it is desirable to improve performance of learning models 116 at the backend of the security service 118 so as to provide responsive and accurate hosted services to client computing devices 108, leading to heightened security of user computing systems embodied by the client computing devices 108.

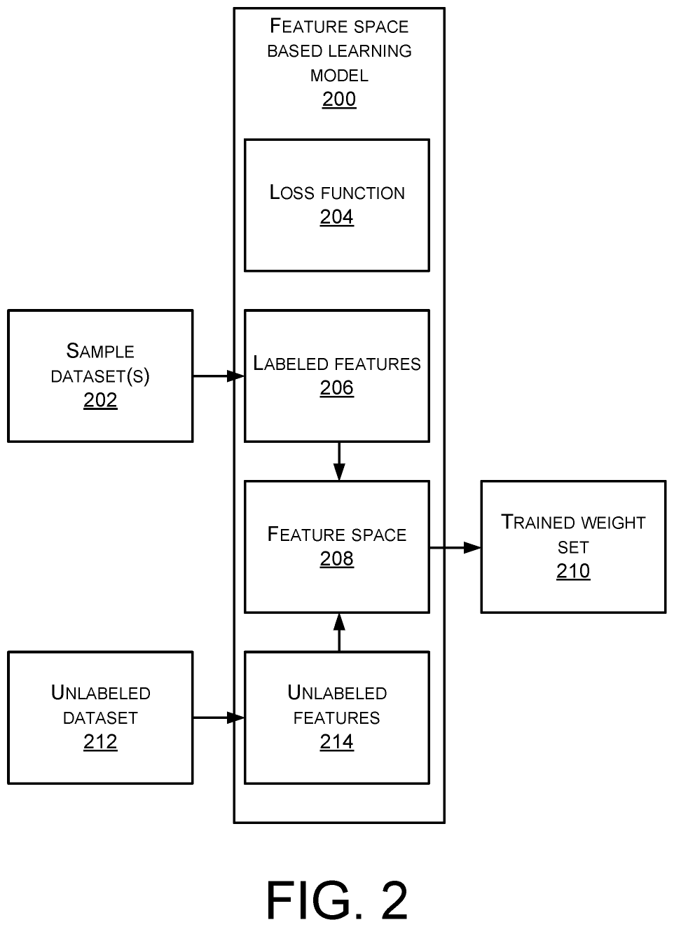

FIG. 2 illustrates a diagram of a feature space based learning model 200 according to examples of the present disclosure. It should be understood that a “feature space based learning model” according to examples of the present disclosure can be any of a classification learning model, a clustering learning model, an anomaly detection learning model, and such learning models which configure a computing host to perform tasks determining whether an unidentified file, represented as a data point in a feature space, is closer to data points labeled as malware, data points labeled as benign files, or data points otherwise labeled. Thus, such a learning model can receive, as input, at least data points and a feature space, and can place the data points into the feature space.

The feature space based learning model 200 may be trained by inputting one or more sample datasets 202 into the feature space based learning model 200. The training of the feature space based learning model 200 may further be performed on a loss function 204, wherein the feature space based learning model 200 extracts labeled features 206 from the sample datasets 202 and embeds the labeled features 206 on a feature space 208 to optimize the loss function 204. Based thereon, the feature space based learning model 200 may generate and update weight sets on the feature space 208 after each epoch of training. After any number of epochs of training in this manner, a trained weight set 210 may be output. The feature space based learning model 200 may subsequently compute tasks such as classification, clustering, outlier or anomaly detection, or other such tasks upon any number of unlabeled datasets 212, extracting unlabeled features 214 from each unlabeled dataset 212 and embedding the unlabeled features 214 in the feature space 208 to optimize an output of the loss function 204, with reference to the trained weight set 210.

The feature space based learning model 200 may be hosted on storage of any computing system as described above, including a cloud computing system, as well as any other computing system having one or more physical or virtual processor(s) capable of executing the learning model to compute tasks for particular functions. For the purpose of examples of the present disclosure, such as computing system hosting the feature space based learning model 200 may be referred to as a “learning system.” The learning system may load the feature space 208 and the trained weight set 210 into memory and execute the feature space based learning model 200 to compute outputs for a classification task, clustering task, outlier or anomaly detection task, or other such tasks to be performed upon unlabeled datasets 212 received from edge nodes 106.

By way of example, the feature space based learning model 200 may configure the learning system to predict similarity of unidentified files to a reference file and/or to classify an unidentified file as clean, malicious, adware, malware, or as any other classification. For instance, the feature space based learning model 200 can configure a learning system to compare a generated hash representing an unidentified sample executable file to a previously generated reference hash value stored in a database from an identified sample executable file. The feature space based learning model 200 can configure a learning system to embed feature vectors extracted from the generated hash into a feature space output by the embedding learning model 300 (to be described subsequently) to derive a first embedded vector (in the form of a matrix, an array, and the like); derive a second embedded vector from embedding feature vectors extracted from the reference hash value into the same feature space; and computing a dot product between the first embedded vector and the second embedded vector, resulting in a similarity score which may range between zero and one, where a larger similarity score represents greater similarity between the files.

The learning system can be configured to refer to a similarity threshold to determine whether the calculated similarity score indicates that the unidentified sample executable file is similar to the identified sample executable file. In example implementations, the learning system can be configured to classify, cluster, or detect as anomalous the unidentified sample executable file using other techniques, such as, for example, calculating an average difference between a first embedded vector and a second embedded vector or by comparing statistical measures calculated over the first embedded vector to reference statistical measures calculated over the second embedded vector.

For example, with regard to tasks relating to the function of classification, commonly available learning models include a residual neural network (“ResNet”) as known to persons skilled in the art.

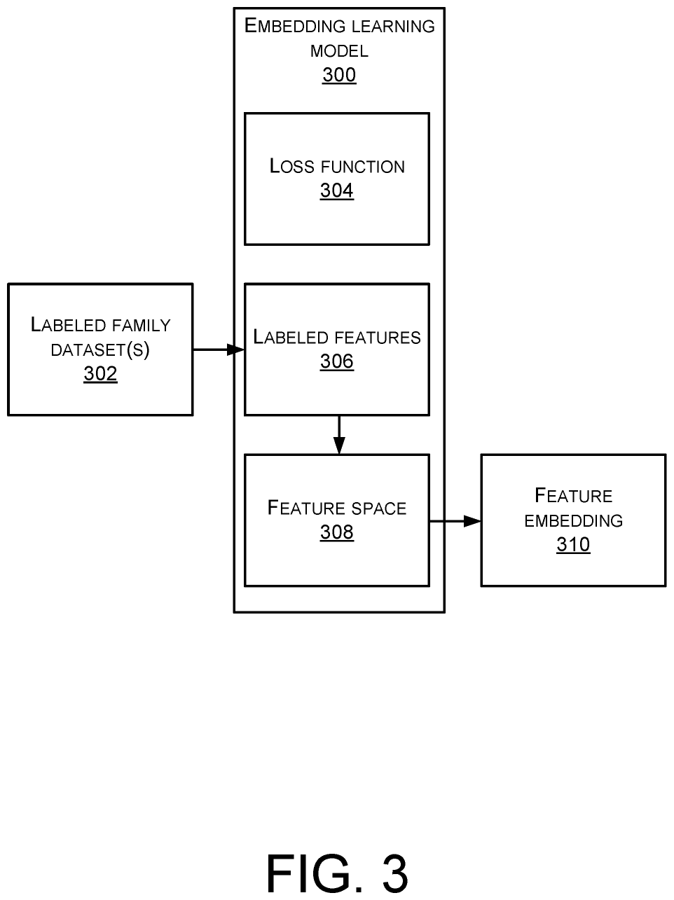

FIG. 3 illustrates a diagram of an embedding learning model 300 according to examples of the present disclosure. The embedding learning model 300 may be trained by inputting one or more labeled datasets 302 into the embedding learning model 300. The training of the embedding learning model 300 may further be performed on a loss function 304, wherein the embedding learning model 300 extracts labeled features 306 from the labeled datasets 302 and embeds the labeled features 306 on a feature space 308 to optimize the loss function 304. Based thereon, the embedding learning model 300 may generate and update weight sets on the feature space 308 after each epoch of training. After any number of epochs of training in this manner, one or more feature embeddings 310 may be output.

The feature embedding 310 may subsequently be referenced in conjunction with a feature space 208 as described above with reference to FIG. 2 so that a feature space based learning model 200 may compute tasks such as classification, clustering, outlier or anomaly detection, and other such tasks by embedding unlabeled features in the feature space 208 based on the feature embedding 310.

The embedding learning model 300 may be hosted on storage of any computing system as described above, including a cloud computing system, as well as any other computing system having one or more physical or virtual processor(s) capable of executing the learning model to compute tasks for particular functions. For the purpose of examples of the present disclosure, such a computing system hosting the embedding learning model 300 may be referred to as an “embedding system,” to denote that it may or may not be a same computing system as a learning system as described above. The embedding system may load the feature space 308 and a weight set into memory and execute the embedding learning model 300 to compute a feature embedding 310 based on the feature space 308.

To further elaborate upon the above-mentioned embedding learning model 300 and how functionalities of the feature space based learning model 200 may be improved by operation of the embedding learning model 300, subsequently steps of methods performed by these learning models will be described in more detail, with steps performed by the embedding learning model 300 described first for ease of understanding.

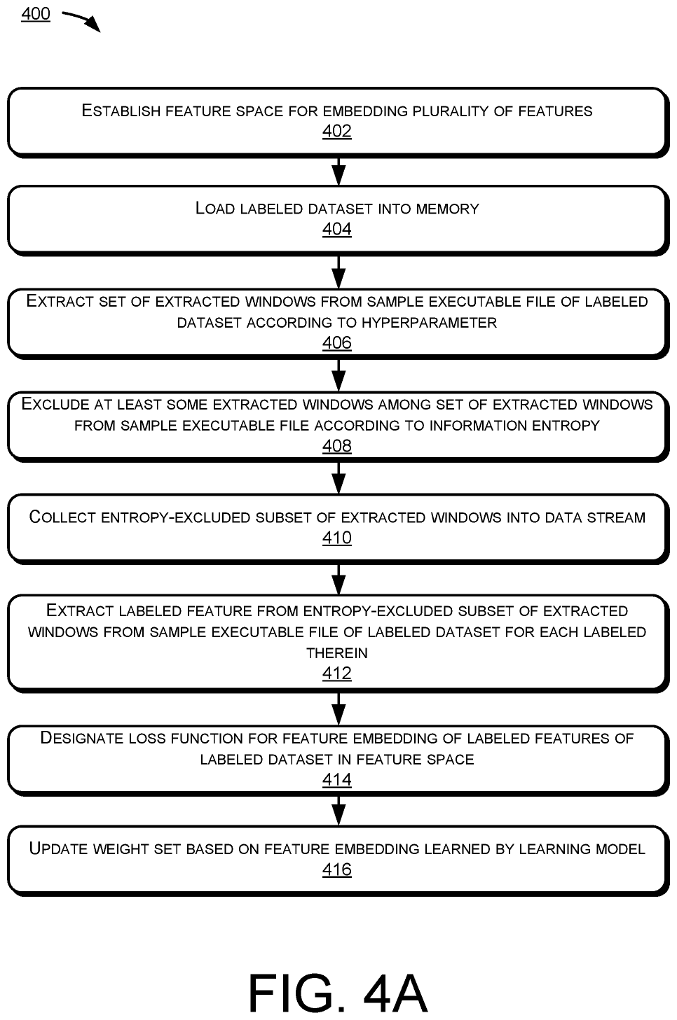

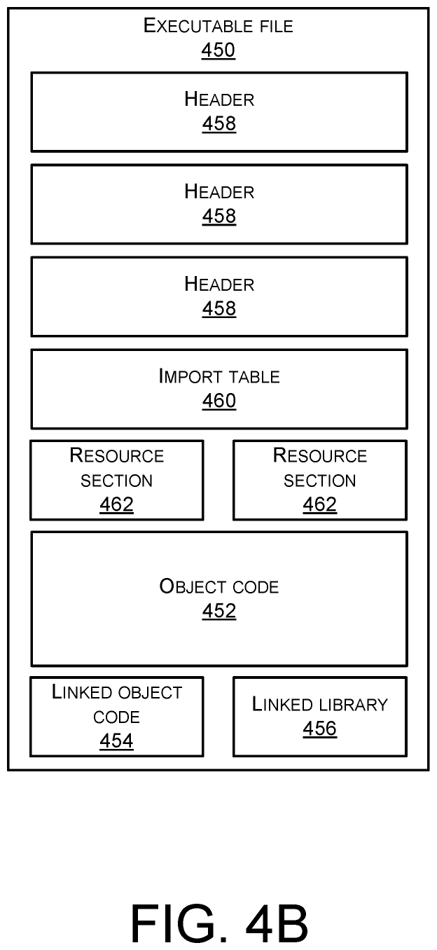

FIG. 4A illustrates a flowchart of an embedding training method 400 according to examples of the present disclosure. Each step of the embedding training method 400 can be performed by one or more processors of an embedding system, such as physical or virtual processors of a cloud computing system as described above with reference to FIG. 1.

In step 402 of the embedding training method 400, one or more processors of an embedding system establish a feature space for embedding a plurality of features.

Feature embedding generally refers to translating features of a dataset into a dimensional space of reduced dimensionality so as to increase, or maximize, distances between data points (such as features from sample datasets as described above) which need to be distinguished in computing a task for a particular function, and decrease, or minimize, distances between data points to be classified, clustered, or otherwise found similar or dissimilar in computing a task for a particular function. For example, functions for expressing distance between two data points may be any function which expresses Euclidean distance, such as L2-norm; Manhattan distance; any function which expresses cosine distance, such as the negative of cosine similarity; any function which expresses information distance, such as Hamming distance; or any other suitable distance function as known to persons skilled in the art. According to examples of the present disclosure, a distance function evaluating two data points x and y may be written as D(x, y).

According to examples of the present disclosure, datasets may be composed of instances of executable files. FIG. 4B illustrates a layout of an executable file 450 according to examples of the present disclosure. An executable file 450 may include, for example, object code 452 compiled to the Portable Executable (“PE”) format executable on computing systems running, for example, Windows operating systems from Microsoft Corporation of Redmond, Washington; object code compiled to the Mach object (“Mach-O”) format executable on computing systems running, for example, MacOS or iOS operating systems from Apple Inc. of Cupertino, California; object code compiled to the Executable and Linkable Format (“ELF”) executable on computing systems running, for example, open-source Linux operating systems or Android operating systems; and the like.

The object code 452 may be further statically or dynamically linked to additional object code 454 and/or libraries 456, which may contain functions, routines, objects, variables, and other source code which may be called in source code, the calls being resolved by a compiler during compilation of the source code to create linked object code which may be executed by a computer as part of the executable file 450.

Additionally, an executable file 450 may include some number of headers 458 which occupy sequences of bytes preceding compiled object code 452 and/or linked object code 454 and/or linked libraries 456; following compiled object code 452 and/or linked object code 454 and/or linked libraries 456; and/or interleaved between compiled object code 452 and/or linked object code 454 and/or linked libraries 456. Executable file formats may define different types of headers 458, as well as sub-headers thereof, containing various sequences of data which may be referenced by object code 452, may be referenced during execution of the executable file 450 at runtime, and so on.

For example, executable file formats may define one or more executable file format-defining headers. Generally, different formats of executable files may define different headers whose inclusion in an executable file define that file as belonging to that respective format. For example, executable files of the PE format may define a Disk Operating System (“DOS”) executable header, a PE header, as well as an optional header (it should be understood that optional headers are called “optional” by naming conventions, and are not necessarily optional for the purpose of understanding examples of the present disclosure). Executable files of the Mach-O format may define a Mach-O header. ELF executable files may define an ELF header.

Additionally, executable file formats may define one or more import tables 460. An import table 460 may resolve references in the object code which link one or more libraries providing functions, routines, objects, variables, and other source code which may be linked to the executable file during compilation or at runtime.

Additionally, executable file formats may include resource sections 462. For example, executable files of the PE Format may include file icon images, image files in general, dialog boxes, and the like. These resources may be stored in one or more discrete sections of the executable file 450.

Formatting of particular types of headers and contents of particular types of headers need not be further detailed for understanding of the present disclosure.

It should be understood that, while object code 452 of an executable file 450 is generated by source code compilers in a computer-executable format, the object code 452 can also be represented in a computer-readable but non-computer-executable format, including as a sequence of ASCII values, and as a sequence of hexadecimal values. Object code 452 of an executable file 450, represented as ASCII values and/or hexadecimal values rather than represented in binary form, can be read by a computing system while being in a non-computer-executable representation.

For example, a computer-readable representation of any given file, including one or more executable files can generally be described as a binary large object (“BLOB”). A BLOB is generally any arbitrarily large data file which can include a computer-readable representation of any arbitrary file format, including representations of object code and other contents of executable files. It should be understood that, although a “BLOB” does not necessarily follow any standard implementation, a BLOB according to examples of the present disclosure should at least represent object code of an executable file in a non-computer-executable format, such as in the form of a sequence of ASCII values or as a sequence of hexadecimal values rather than binary form, as mentioned above.

For brevity, any such non-computer-executable representation, however stored on a computing system, shall be referred to herein as a “sample.”

In step 404 of the embedding training method 400, one or more processors of the embedding system load a labeled dataset into memory.

Datasets may include labeled malware samples, labeled benign file samples, and any combination thereof. A dataset may include at least samples of executable files labeled as various known malware. For the purpose of examples of the present disclosure, malware should be understood as encompassing known executable files which are executable by computing systems to perform particular malicious operations to infect, damage, hijack, destabilize, or otherwise harm normal functioning of the computing system by various pathways. Benign files should be understood as any executable files which are not executable by computing systems in such fashions.

Features of sample executable files may be statically or dynamically detectable features. Statically detectable features may be features of the executable files which are present outside of runtime, such as a string of text present in the executable files, a checksum of part of all of the source code such as an MD5 hash, and such features as known to exist in executable files outside of runtime. Dynamically detectable features may be operations performed by a computing system executing the executable file during runtime, such as read or write accesses to particular memory addresses, read or write accesses of memory blocks of particular sizes, read or write accesses to particular files on non-volatile storage, and the like.

An embedding learning model according to examples of the present disclosure may be trained to generate a feature embedding for a labeled dataset representing malware samples, benign file samples, and any combination thereof. The labeled dataset may include samples of executable files, each sample being labeled as having one or more of multiple distinct features. Any number of these features, alone or in combination, may distinguish executable files labeled as one kind of malware from executable files labeled as another kind of malware; distinguish executable files labeled as any kind of malware from executable files labeled as benign files; distinguish executable files of one cluster from executable files of another cluster, whether one or both clusters contain executable files labeled as malware; distinguish executable files belonging to one malware family from executable files belonging to all other malware families; distinguish statistically normal executable files from statistical outlier or statistically anomalous executable files; and the like.

A feature embedding may be an embedding of each sample of the labeled dataset into a feature space as described above. Furthermore, according to examples of the present disclosure, it is desirable that a feature embedding causes each labeled feature among the labeled dataset to be distinguished from each other labeled feature among the labeled dataset as much as possible. Thus, it is desirable that for each particular labeled feature, samples having that particular labeled feature be embedded having as little distance from each other as possible, and, conversely, having as much distance from samples having other labeled features as possible.

According to other examples of the present disclosure, one or more processors of an embedding system may optionally load at least one labeled malware dataset and at least one labeled benign software dataset into memory, separate from each other. It should be understood that a labeled benign software dataset may merely be labeled as benign for distinction from labeled malware samples in general, and that, moreover, for the purpose of examples of the present disclosure, with regard to sample executable files labeled as benign, no particular features thereof need be labeled, as there are not necessarily commonalities among samples of benign software which may be distinguished from features of malware.

Moreover, though a labeled benign software dataset may be used for purposes of examples of the present disclosure, it may, or may not, be used alongside a labeled malware dataset.

In step 406 of the embedded training method 400, one or more processors of the embedding system extract a set of extracted windows from a sample executable file of the labeled dataset according to a hyperparameter.

Distinct from parameters, processors of a computing system do not learn a hyperparameter while training a learning model. Instead, processors of a computing system configured to run a machine learning model may determine a hyperparameter outside of training the learning model. In this manner, a hyperparameter may reflect intrinsic characteristics of the learning model which will not be learned, or which will determine performance of the processors of the computing system during the learning process.

Thus, optimizing a loss function may refer to the process of training the machine learning model, while optimizing a hyperparameter may refer to the process of determining a hyperparameter before training the machine learning model. One or more processors of the computing system can determine hyperparameters by an additional optimization computation.

According to examples of the present disclosure, hyperparameters can define at least a window size and a window distance (which can each be specified in bits or in bytes), and one or more processors of the embedding system can extract sub-sequences of bits from a sample of the labeled dataset, each sub-sequence having a length corresponding to the window size hyperparameter, and sub-sequences being spaced apart according to the window distance hyperparameter.

By way of example, a window size hyperparameter can have a value of 256 bytes, 1028 bytes, 1 megabyte, or otherwise some multiple of 8 bytes. A window distance hyperparameter can likewise have a value of some multiple of 8 bytes, such as 1028 bytes.

Based on the window size hyperparameter and the window distance hyperparameter, one or more processors of the embedding system can extract some or all possible sub-sequence of bytes from a same sample of the labeled subset: i.e., the one or more processors can traverse a sample executable file of the labeled subset, and extract, along a sequence of bytes making up the sample, some sub-sequences or substantially all sub-sequences having a length corresponding to the window size hyperparameter, and spaced apart according to the window distance hyperparameter. Thus, these sub-sequences do not overlap.

Subsequently, the set of windows extracted from a same sample of the labeled dataset can be referred to herein as a “set of extracted windows,” for short. Different sets of extracted windows can be taken from different samples of the labeled dataset.

In a step 408 of the embedding training method 400, one or more processors of the embedding system excludes at least some extracted windows among a set of extracted windows from a sample executable file of the labeled dataset according to information entropy.

Information entropy over a sequence of bytes making up a sample executable file can be quantified as, for example, Shannon entropy. It should be understood that one or more processors of any computing system can be configured to compute Shannon entropy for a sequence of bytes as an approximation of the average number of bits required to encode the sequence of bytes without loss of information. Therefore, low information entropy may indicate that the same ASCII values or hexadecimal values recur frequently, requiring fewer bits to encode the entire sequence; high information entropy may indicate that the same ASCII values or hexadecimal values rarely recur, requiring more bits to encode the entire sequence. Given a value of the window size hyperparameter which is sufficiently large, each extracted window can contain sufficient heterogeneous bytes which allow information entropy computations for different extracted windows to yield substantially heterogeneous information entropy values, facilitating comparison of information entropy between different extracted windows.

Therefore, for a sequence of bytes making up any given sample executable file, statistically, some regions can be high in information entropy, other regions can be low in information entropy, and yet other regions can be neither high nor low in information entropy.

According to examples of the present disclosure, in accordance with statistical observations, training the embedding learning model (as shall be subsequently described) using n-grams taken from regions neither high nor low in information entropy can result in the trained learning model exhibiting improved performance, compared to training the embedding learning model using n-grams taken from regions high in information entropy and/or training the embedding learning model n-grams taken from regions low in information entropy.

Thus, given a set of extracted windows, one or more processors of any computing system can be configured to compute information entropy for each among a set of extracted windows; determine a first subset of extracted windows having highest information entropy; determine a second subset of extracted windows having lowest information entropy; and exclude both the first subset and the second subset. Thus, the post-exclusion set of extracted windows can substantially exclude regions of the sample executable file which are high in information entropy and which are low in information entropy. Given a value of the window distance hyperparameter which is sufficiently large, each extracted window can be sufficiently spaced apart so as to minimize variations in information entropy within a same extracted window, and maximize the likelihood that each extracted window represents a substantially distinct region of information entropy relative to other extracted windows.

According to examples of the present disclosure, extracted windows can be considered “highest” in information entropy or “lowest” in information entropy according to a set proportion of all extracted windows ordered from highest to lowest information entropy: for example, a top 5% among the ordered extracted windows can be considered “highest” in information entropy, and a bottom 5% among the ordered extracted windows can be considered “lowest” in information entropy.

Alternatively, extracted windows can be considered “highest” in information entropy or “lowest” in information entropy according to a set number of all extracted windows ordered from highest to lowest information entropy: for example, a top 1000 among the ordered extracted windows can be considered “highest” in information entropy, and a bottom 1000 among the ordered extracted windows can be considered “lowest” in information entropy.

After at least some extracted windows among a set of extracted windows are extracted according to information entropy, the resulting subset can be subsequently referred to as an “entropy-excluded subset of extracted windows.”

In step 410 of the embedding training method 400, one or more processors of the embedding system collects the entropy-excluded subset of extracted windows into a data stream.

It should be understood that a data stream can be implemented according to various data structures which can store a sequence of bytes, where one or more processors of the embedding system can be configured to read the various data structures so as to sequentially access ASCII values or hexadecimal values contained in the sequence of bytes. For example, a data stream can be implemented in one or more buffer data structures in which a sequence of bytes can be stored.

Thus, one or more processors of the computing system can store the entropy-excluded subset of extracted windows in one or more data structures making up the data stream, so that the one or more processors can then sequentially access the ASCII values or hexadecimal values stored in the data stream.

It should be understood that the extracted windows can be stored in the data stream in their order of extraction from a sample executable file, or stored in any arbitrary order.

A data stream may contain an entropy-excluded subset of extracted windows from a sample executable file, which, as described above, can have one or more labels.

In step 412 of the embedding training method 400, one or more processors of the embedding system extract a labeled feature from an entropy-excluded subset of extracted windows from a sample executable file of the labeled dataset for each label therein.

According to examples of the present disclosure, a feature extracted from an entropy-excluded subset of extracted windows may be a sequence of bytes extracted from a header of the sample executable file or a sub-header of the sample executable file. A header or sub-header of the sample executable file may be, for example, an executable file format-defining header, such as a DOS executable header, a PE header, or an optional header.

According to examples of the present disclosure, a feature extracted from an entropy-excluded subset of extracted windows may be a sequence of bytes extracted from executable sections of object code. A feature may include, for example, some number of consecutive bytes of an executable section of the object code. A feature may be extracted from a first executable section of object code, or from a last executable section thereof, or from any n-th executable section thereof.

According to examples of the present disclosure, a feature extracted from an entropy-excluded subset of extracted windows may be a sequence of bytes extracted from resource sections of executable files. A feature may include, for example, some number of bytes of any resource of a resource section of the executable file. A feature may be extracted from a first resource of a resource section, or from a last resource of the resource section, or from any n-th resource of the resource section.

According to examples of the present disclosure, a feature extracted from an entropy-excluded subset of extracted windows may be a sequence of bytes extracted from an import table. A feature may include, for example, some number of bytes of any one or more strings of an import table.

According to examples of the present disclosure, a feature extracted from an entropy-excluded subset of extracted windows may be one or more sequences of bytes including any combination of the above examples.

According to examples of the present disclosure, one or more sequences of bytes as described above may be taken from a data stream storing an entropy-excluded subset of extracted windows from a sample executable file (rather than from the original sample executable file, and rather than from the original set of extracted windows from the sample executable file) by taking any number of n-grams (i.e., arbitrarily taking contiguous sequences of n bytes from a sequence of longer than n bytes, without regard as to the content of the n-gram or the content of the longer sequence) from sequentially accessed bytes of the data stream.

Since all extracted windows of the subset are stored in the data stream sequentially, an n-gram can include bytes from one extracted window or more than one extracted window. Even if an n-gram includes bytes which were not contiguous in the original sample executable file, this is not expected to substantially impact performance of the trained embedding learning model (as shall be described subsequently): since n-grams are much smaller in length than extracted windows, such n-grams spanning more than one extracted window will be very few in number. Furthermore, since the subset of extracted windows is entropy-excluded, there is less likely to be substantial differences in information entropy in an n-gram spanning more than one extracted window.

One or more processors of an embedding system can be configured to take n-grams from the data stream at increments according to a sliding window. One or more processors of an embedding system can be configured to take n-grams at intervals of bytes over a data stream, such as a computer-readable representation of object code of an executable file.

Thus, one or more processors of an embedding system according to examples of the present disclosure can be configured to take n-grams, for any value of n bytes, over an interval of any value across a computer-readable representation of object code of an executable file stored in a data stream. Furthermore, the interval can be smaller than the value of n, such that each n-gram overlaps in part with other n-grams taken earlier and subsequently.

By way of example, the value of n can be 4 and the size of the interval can be 1, such that the one or more processors of an embedding system take, at every byte of the data stream, every 4-gram of the data stream. In other words, the one or more processors are configured to take every contiguous sequence of 4 bytes from the data stream as a different n-gram.

Therefore, given a data stream storing k bytes, the value of n being 4, and the size of the interval being 1, one or more processors of an embedding system are configured to take (k-3) 4-grams from the data stream in total.

By way of another example, if the size of the interval is 2 instead of 1, the one or more processors are configured to take every other contiguous sequence of 4 bytes from the data stream as a different n-gram.

Subsequently, “n-gram” shall be used without limitation as to the particular value of n, where n can be any value equal to or greater than 1.

It should be understood that one or more processors of an embedding system can be configured to take n-grams from a data stream according to other values of n and other sizes of the interval, without limitation. Larger intervals can configure one or more processors of an embedding system to take fewer n-grams, reducing computational complexity, but reducing granularity of the sliding window. However, according to examples of the present disclosure, it should be understood that the interval size can be as small as 1, such that every possible sliding window is taken from a data stream.

A feature may be represented as a feature vector encompassing some number of bits therein. By way of example, the 32 bits making up each 4-gram of the data stream can be represented as a trainable embedding vector {0, 1, 2, . . . , 31}, wherein each dimension of the vector represents one bit; as a trainable embedding vector {0, 1, 2, . . . , 15}, wherein each dimension of the vector represents two bits; as a trainable embedding vector {0, 1, 2, . . . , 7}, wherein each dimension of the vector represents a nibble making up four bits (where each nibble can be represented as an integer between 0 and 15 given a sequence of ASCII values, or as a single hexadecimal digit 0-F given a sequence of hexadecimal values); as a trainable embedding vector {0, 1, 2, . . . , 7}, wherein each dimension of the vector represents asymmetrical nibbles (i.e., each making up alternatingly six bits and two bits, or two bits and six bits); as a trainable embedding vector {0, 1, 2, 3}, wherein each dimension of the vector represents a byte; and as any other trainable embedding vector that encompasses the 32 bits making up the 4-gram. Other n-grams, for different values of n, can be represented as various trainable embedding vectors in an analogous fashion.

In accordance with statistical observations, among n-grams taken from a data stream, each n-gram has a particular probability of occurring in any given random executable file (subsequently referred to as “probability of occurrence,” for brevity, without regard as to the nature of the file, and without regard as to where in the file the n-gram may appear). Some particular n-grams have a higher probability of occurrence, while other particular n-grams have a lower probability of occurrence.

Thus, according to examples of the present disclosure, one or more processors of the embedding system are configured to train the embedding learning model (as shall be subsequently described) by inputting any feature vector as described above, such that the embedding learning model configures the one or more processors of the embedding system to output a predicted frequency (or a representation of the predicted frequency by a logarithm, scaled logarithm, and the like) of the sequence of bytes featurized by the feature vector occurring across random files.

Since the feature vector is taken from an entropy-excluded subset of extracted windows, training the embedding learning model by inputting such feature vectors is expected to improve accuracy of predictions, compared to cases where the embedded learning model is trained by inputting feature vectors taken from extracted windows high in information entropy and/or feature vectors taken from extracted windows low in information entropy.

In step 414 of the embedding training method 400, one or more processors of the embedding system designates a loss function for feature embedding of labeled features of the labeled dataset in the feature space.

A loss function, which may be more generally an objective function or a component of an objective function, is generally any mathematical function having an output which may be optimized during the training of a learning model.

One or more processors of the embedding system can be configured to perform training of the learning model, at least in part, on at least the designated loss function to learn a feature embedding of labeled features of the labeled dataset in the feature space. One or more processors of the embedding system may be configured to learn the designated loss function by iteratively tuning parameters of the loss function over epochs of the training process. For example, the loss function may be any function having one distance or more than one distance as parameters, where one or more parameters of the loss function may be optimized, simultaneously, in alternation, or in any other fashion over iterations, for minimal values of at least distance and/or maximal values of at least one distance.

In step 416 of the embedding training method 400, one or more processors of the embedding system train the embedding learning model on the designated loss function for embedding each labeled feature of the labeled dataset in the feature space.

For the purpose of such training, samples of the labeled dataset may be divided into multiple batches, where samples of each batch may be randomly selected from the labeled dataset, without replacement. Each batch may be equal in size. Thus, each batch is expected, statistically, to contain approximately similar numbers of samples of each labeled feature on average.

According to examples of the present disclosure, batch sizes may be set so as to increase probability that each batch includes at least one positive data point for each labeled feature and at least one negative data point for each labeled feature. Thus, batch sizes should not be so small that these requirements are not met.

In step 418 of the embedding training method 400, one or more processors of the embedding system update a weight set based on a feature embedding learned by the learning model.

A weight set may include various parameters which determine the operation of the embedding learning model in embedding each labeled feature of the labeled dataset in the feature space. The training as performed in the above-mentioned training phases may be reflected in updates to the weight set. The weight set may be updated according to gradient descent (“GD”) (that is, updated after computation completes for an epoch), stochastic gradient descent (“SGD”), mini-batch stochastic gradient descent (“MB-SGD”) (that is, updated after computation of each batch), backpropagation (“BP”), or any suitable other manner of updating weight sets as known to persons skilled in the art.

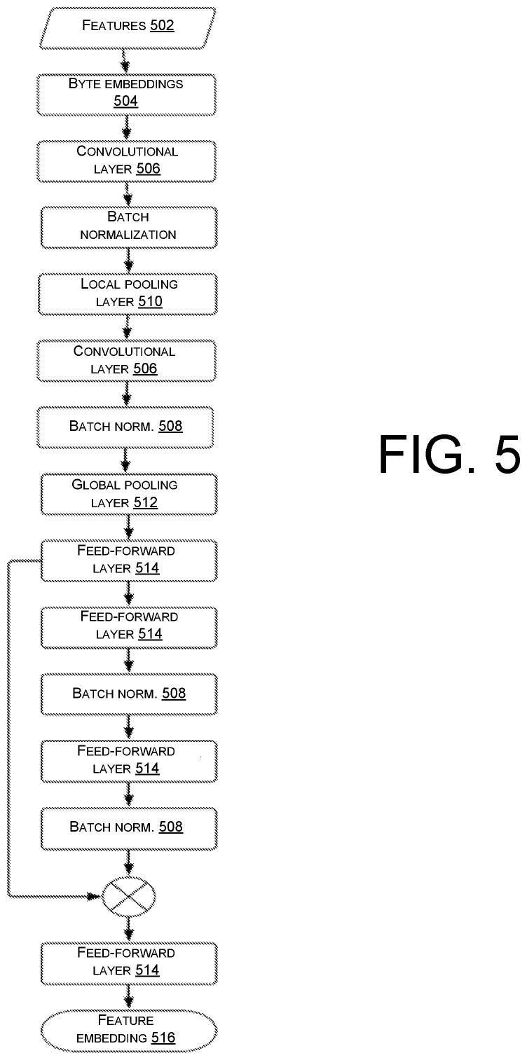

FIG. 5 illustrates an architectural diagram of an embedding learning model 500 according to examples of the present disclosure.

The embedding learning model 500 may extract features 502 from a data stream, as described above with reference to FIG. 4A.

The features 502 may be represented as byte embeddings 504 as described above.

The byte embeddings 504 may be input into a first layer of multiple convolutional layers 506 of the embedding learning model 500. Each subsequent convolutional layers 506 after the first may take output of a previous convolutional layer 506 as input.

Input at any convolutional layer 506 (including outputs of previous convolutional layers 506) may be batch-normalized at each batch normalization 508 as known to persons skilled in the art.

Outputs from each convolutional layer 506 may be input into a pooling layer, which may be, for example, a local pooling layer 510 or a global pooling layer 512 as known to persons skilled in the art. Local pooling layers 510 and global pooling layers 512 may each cause features to be down-sampled so as to retain features which are present, without retaining features which are absent. A global pooling layer 512 may receive output from a final convolutional layer 506 of the embedding learning model 500, and may down-sample features with regard to each channel of the output feature embeddings; thus, each individual channel of the output feature embeddings of the global pooling layer 512 may retain a feature which is present therein, without retaining features which are absent therein.

Output from the global pooling layer 512 may be input into a first layer of multiple feed-forward layers 514. Output from each feed-forward layer 514 may be input into a next feed-forward layer 514 without cycling back, as known to persons skilled in the art. Moreover, output from a feed-forward layer 514 may be input as residuals into subsequent feed-forward layers 514 after a next feed-forward layer 514. By way of example, the structure of the multiple feed-forward layers 514 may be implemented by a residual neural network (“ResNet”) as known to persons skilled in the art.

Inputs at any feed-forward layer 514 may be batch-normalized at each batch normalization 508 as known to persons skilled in the art.

A final feed-forward layer 514 outputs a feature embedding 516 as described above.

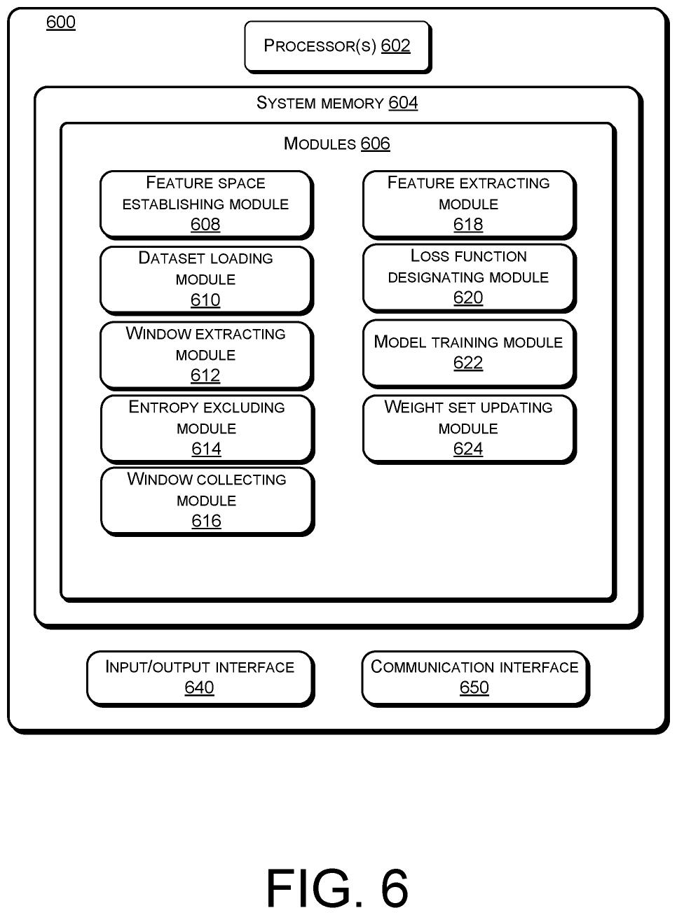

FIG. 6 illustrates an example computing system 600 for implementing the processes and methods described above for implementing embedding learning models and entropy exclusion of labeled training data.

The techniques and mechanisms described herein may be implemented by multiple instances of the computing system 600, as well as by any other computing device, system, and/or environment. The computing system 600 may be a distributed system composed of multiple physically networked computers or web servers, a physical or virtual cluster, a computing cloud, or other networked computing architectures providing physical or virtual computing resources as known by persons skilled in the art. Examples thereof include computing hosts as described above with reference to FIG. 1, learning systems as described above with reference to FIG. 2, and embedding system as described above with reference to FIG. 3. The computing system 600 shown in FIG. 6 is only one example of a system and is not intended to suggest any limitation as to the scope of use or functionality of any computing device utilized to perform the processes and/or procedures described above. Other well-known computing devices, systems, environments and/or configurations that may be suitable for use with the examples include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 600 may include one or more processors 602 and system memory 604 communicatively coupled to the processor(s) 602. The processor(s) 602 and system memory 604 may be physical or may be virtualized and/or distributed. The processor(s) 602 may execute one or more modules and/or processes to cause the processor(s) 602 to perform a variety of functions. By way of example, the processor(s) 602 may include one or more general-purpose processor(s) and one or more special-purpose processor(s). The general-purpose processor(s) and special-purpose processor(s) may be physical or may be virtualized and/or distributed. The general-purpose processor(s) and special-purpose processor(s) may execute one or more instructions stored on a computer-readable storage medium as described below to cause the general-purpose processor(s) or special-purpose processor(s) to perform a variety of functions. General-purpose processor(s) may be computing devices operative to execute computer-executable instructions, such as Central Processing Units (“CPUs”). Special-purpose processor(s) may be computing devices having hardware or software elements facilitating computation of neural network computing tasks such as training and inference computations. For example, special-purpose processor(s) may be accelerator(s), such as Neural Network Processing Units (“NPUs”), Graphics Processing Units (“GPUs”), Tensor Processing Units (“TPU”), implementations using field programmable gate arrays (“FPGAs”) and application specific integrated circuits (“ASICs”), and/or the like. To facilitate computation of tasks such as matrix multiplication, special-purpose processor(s) may, for example, implement engines operative to compute mathematical operations such as matrix operations and vector operations. Additionally, each of the processor(s) 602 may possess its own local memory, which also may store program modules, program data, and/or one or more operating systems.

Depending on the exact configuration and type of the system 600, the system memory 604 may be volatile, such as RAM, non-volatile, such as ROM, flash memory, miniature hard drive, memory card, and the like, or some combination thereof. The system memory 604 may include one or more computer-executable modules 606 that are executable by the processor(s) 602. The modules 606 may be hosted on a network as services for a data processing platform, which may be implemented on a separate system from the system 600.

The modules 606 may include, but are not limited to, a feature space establishing module 608, a dataset loading module 610, a window extracting module 612, an entropy excluding module 614, a window collecting module 616, a feature extracting module 618, a loss function designating module 620, a model training module 616, and a weight set updating module 618.

The feature space establishing module 608 may be executable by the processor(s) 602 to establish a feature space for embedding a plurality of features as described above with reference to FIG. 4A.

The dataset loading module 610 may be executable by the processor(s) 602 to load a labeled family dataset into memory as described above with reference to FIG. 4A.

The window extracting module 612 may be executable by the processor(s) 602 to extract windows from a sample of the labeled dataset according to a hyperparameter as described above with reference to FIG. 4A.

The entropy excluding module 614 may be executable by the processor(s) 602 to exclude at least some among a set of extracted windows from a sample of the labeled dataset according to information entropy as described above with reference to FIG. 4A.

The window collecting module 616 may be executable by the processor(s) 602 to collect the entropy-excluded subset of extracted windows into a data stream as described above with reference to FIG. 4A.

The feature extracting module 618 may be executable by the processor(s) 602 to extract a labeled feature from an entropy-excluded subset of extracted windows from a sample executable file of the labeled dataset for each label therein as described above with reference to FIG. 4A.

The loss function designating module 620 may be executable by the processor(s) 602 to designate a loss function for feature embedding of labeled features of the labeled dataset in the feature space as described above with reference to FIG. 4A.

The model training module 622 may be executable by the processor(s) 602 to train the embedding learning model on the designated loss function for embedding each labeled feature of the labeled dataset in the feature space as described above with reference to FIG. 4A.

The weight set updating module 624 may be executable by the processor(s) 602 to update a weight set based on a feature embedding learned by the learning model as described above with reference to FIG. 4A.

The computing system 600 may additionally include an input/output (I/O) interface 640 and a communication module 650 allowing the computing system 600 to communicate with other systems and devices over a network, such as the data processing platform, a computing device of a data owner, and a computing device of a data collector. The network may include the Internet, wired media such as a wired network or direct-wired connections, and wireless media such as acoustic, radio frequency (RF), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 1-5. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

By the abovementioned technical solutions, the present disclosure provides entropy exclusion of labeled training data by extracting windows therefrom, for training an embedding learning model to output a feature space for a feature space based learning model. Based on feature embedding by machine learning, a machine learning model is trained to embed feature vectors in a feature space which magnifies distances between features of a labeled dataset. Before training, however, sub-sequences of bytes are extracted from each sample of the labeled subset, based on a window size hyperparameter and a window distance hyperparameter. Information entropy is computed for each among a set of extracted windows, and extracted windows having highest information entropy, as well as extracted windows having lowest information entropy, are excluded therefrom. Extracted windows of the subset are stored in a data stream and accessed sequentially to derive feature vectors. Since the feature vector is taken from an entropy-excluded subset of extracted windows, training the embedding learning model by inputting such feature vectors is expected to improve accuracy of predictions, compared to cases where the embedded learning model is trained by inputting feature vectors taken from extracted windows high in information entropy and/or feature vectors taken from extracted windows low in information entropy.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A method comprising:
extracting a set of extracted windows from a sample executable file of a labeled dataset according to a hyperparameter;
excluding at least some extracted windows among the set of extracted windows according to information entropy to derive an entropy-excluded subset of extracted windows; and
extracting a labeled feature from the entropy-excluded subset of extracted windows for feature embedding of labeled features in a feature space.

2. The method of claim 1, wherein an extracted window of the set of extracted windows comprises a sub-sequence having a length corresponding to a window size hyperparameter, sub-sequences being spaced apart according to a window distance hyperparameter.

3. The method of claim 1, further comprising determining a first subset among the set of extracted windows having highest information entropy; determining a second subset among the set of extracted windows having lowest information entropy; and excluding the first subset and the second subset from the set of extracted windows.

4. The method of claim 3, wherein extracted windows highest in information entropy and lowest in information entropy are determined according to a set proportion of all extracted windows ordered from highest to lowest information entropy.

5. The method of claim 3, wherein extracted windows highest in information entropy and lowest in information entropy are determined according to a set number of all extracted windows ordered from highest to lowest information entropy.

6. The method of claim 1, further comprising collecting the entropy-excluded subset of extracted windows into a data stream; and
wherein extracting a labeled feature comprises taking n-grams at intervals of bytes over the data stream.

7. The method of claim 6, wherein the data stream comprises one or more data structures storing the entropy-excluded subset of extracted windows in order of extraction from the sample executable file, or in an order arbitrary from the order of extraction.

8. A system comprising:
one or more processors; and
memory communicatively coupled to the one or more processors, the memory storing computer-executable modules executable by the one or more processors that, when executed by the one or more processors, perform associated operations, the computer-executable modules comprising:
a window extracting module executable by the one or more processors to extract a set of extracted windows from a sample executable file of a labeled dataset according to a hyperparameter;
an entropy excluding module executable by the one or more processors to exclude at least some extracted windows among the set of extracted windows according to information entropy to derive an entropy-excluded subset of extracted windows; and
a feature extracting module executable by the one or more processors to extract a labeled feature from the entropy-excluded subset of extracted windows.

9. The system of claim 8, wherein an extracted window of the set of extracted windows comprises a sub-sequence having a length corresponding to a window size hyperparameter, sub-sequences being spaced apart according to a window distance hyperparameter.

10. The system of claim 8, wherein the entropy excluding module is further executable by the one or more processors to determine a first subset among the set of extracted windows having highest information entropy; determine a second subset among the set of extracted windows having lowest information entropy; and exclude the first subset and the second subset from the set of extracted windows.

11. The system of claim 10, wherein extracted windows highest in information entropy and lowest in information entropy are determined according to a set proportion of all extracted windows ordered from highest to lowest information entropy.

12. The system of claim 10, wherein extracted windows highest in information entropy and lowest in information entropy are determined according to a set number of all extracted windows ordered from highest to lowest information entropy.

13. The system of claim 12, further comprising a window collecting module executable by the one or more processors to collect the entropy-excluded subset of extracted windows into a data stream; and
wherein the feature extracting module is executable by the one or more processors to extract a labeled feature comprises taking n-grams at intervals of bytes over the data stream.

14. The system of claim 13, wherein the data stream comprises one or more data structures storing the entropy-excluded subset of extracted windows in order of extraction from the sample executable file, or in an order arbitrary from the order of extraction.

15. A computer-readable storage medium storing computer-readable instructions executable by one or more processors, that when executed by the one or more processors, cause the one or more processors to perform operations comprising:
extracting a set of extracted windows from a sample executable file of a labeled dataset according to a hyperparameter;
excluding at least some extracted windows among the set of extracted windows according to information entropy to derive an entropy-excluded subset of extracted windows; and
extracting a labeled feature from the entropy-excluded subset of extracted windows.

16. The computer-readable storage medium of claim 15, wherein an extracted window of the set of extracted windows comprises a sub-sequence having a length corresponding to a window size hyperparameter, sub-sequences being spaced apart according to a window distance hyperparameter.

17. The computer-readable storage medium of claim 15, wherein the operations further comprise determining a first subset among the set of extracted windows having highest information entropy; determining a second subset among the set of extracted windows having lowest information entropy; and excluding the first subset and the second subset from the set of extracted windows.

18. The computer-readable storage medium of claim 17, wherein extracted windows highest in information entropy and lowest in information entropy are determined according to a set proportion of all extracted windows ordered from highest to lowest information entropy.

19. The computer-readable storage medium of claim 17, wherein extracted windows highest in information entropy and lowest in information entropy are determined according to a set number of all extracted windows ordered from highest to lowest information entropy.

20. The computer-readable storage medium of claim 19, wherein the operations further comprise collecting the entropy-excluded subset of extracted windows into a data stream; and
wherein extracting a labeled feature comprises taking n-grams at intervals of bytes over the data stream.
